(19) United States
(12) Patent Application Publication
(10) Pub. No.: US 2014/0292609 A1
(43) Pub. Date: Oct. 2, 2014

(54) Device and Process for Reduction of Passive Intermodulation

(71) Applicant: Dielectric, LLC, Raymond, ME (US)

(72) Inventor: John L. Schadler, Raymond, ME (US)

(21) Appl. No.: 14/243,063

(22) Filed: Apr. 2, 2014

Related U.S. Application Data
(60) Provisional application No. 61/807,442, filed on Apr. 2, 2013.

(51) Int. Cl. H01Q 1/50

(52) U.S. Cl. CPC H01Q 1/50
USPC 343/850

(57) ABSTRACT

An antenna includes a plurality of metallic components, the plurality of metallic components arranged to provide transmission of a high-power broadcast signal. The antenna further includes at least two of the plurality of metallic components being configured to be connected to one another, an insulating material arranged between the at least two of the plurality of metallic components, and nonmetallic mechanical fasteners holding the at least two of the plurality of metallic components together.

### CROSS-REFERENCE TO RELATED APPLICATIONS

This application claims the benefit from U.S. Provisional Application No. 61/807,442 filed on Apr. 2, 2013, which is hereby incorporated by reference in its entirety for all purposes as if fully set forth herein.

### FIELD OF THE INVENTION

The invention relates to devices and processes for reduction of passive intermodulation. More particularly, the invention relates to devices and processes for reduction of passive intermodulation in high-power applications.

### BACKGROUND OF THE INVENTION

Passive Intermodulation (PIM) occurs when two or more signals at different frequencies are passed through a passive device (antenna, transmission line, switch, or the like) that exhibits a non-linear response. For example, non-linear junctions, components that are subject to thin film effect (metallic and thin films support current flow differently), metal (conductivity), thin films (tunneling effect, Schottky effect, electrons that “jump” a barrier, and so on), and the like.

Reduction of PIM is critically important for high-power applications, such as broadcast transmissions that exceed a 5 kW. The resulting PIM generated from high-power applications can detrimentally affect many other adjacent frequencies to these high-power application frequencies. For example, other frequencies may experience higher levels of signal to noise ratio, static, interference, and the like. Moreover, prior art approaches to reducing PIM do not work effectively with high-power applications because the high-power applications require different technical approaches to the transmission of high-power signals including much larger transmission lines, connectors, and so on.

Accordingly, processes and devices are needed to reduce PIM in high-power applications such as broadcast transmission.

### SUMMARY OF THE INVENTION

The foregoing needs are met, to a great extent, by the invention, wherein in one aspect a technique and apparatus are provided to reduce PIM in high-power applications.

In one aspect and an antenna includes a plurality of metallic components, the plurality of metallic components arranged to provide transmission of a high-power broadcast signal, at least two of the plurality of metallic components being configured to be connected to one another, an insulating material arranged between the at least two of the plurality of metallic components, and nonmetallic mechanical fasteners holding the at least two of the plurality of metallic components together.

The metallic components may include couplers and the insulating material may be arranged between the couplers and the antenna. The couplers may be attached to the antenna with nonmetallic fasteners. The metallic components may include a bucket and the insulating material is an airspace between the bucket and the antenna. The bucket may be attached to the antenna with nonmetallic fasteners and wherein the bucket may have a length of one quarter (¼) of a wavelength in order to be bucket shorted. The metallic components may include a parasitic floating tilted dipole and the insulating material may include dielectric material arranged between the parasitic floating tilted dipole and the antenna. The parasitic floating tilted dipole may be attached to the antenna with nonmetallic fasteners. The metallic components may include a tubular conductor and a stub, and the insulating material may be arranged between the tubular conductor and the stub. The antenna may include a cover configured to cover an opening in the antenna, wherein the cover may be attached to the antenna with the non-metallic fasteners. The cover may be configured maintain an inert gas within the antenna. The antenna may further include a transmission line, and a plurality of connectors arranged along the transmission line, wherein the plurality of connectors have similar PIM generation, and wherein a spacing between the plurality connectors along the transmission line being expressed by the formula: ((2n+1)/4)×wavelength (where n is 0, 1, 2, 3, . . . ).

Another aspect, an antenna includes a plurality of metallic components, the plurality of metallic components arranged to provide transmission of a high-power broadcast signal, at least two of the plurality of metallic components being configured to be connected to one another, an insulating material arranged between the at least two of the plurality of metallic components, nonmetallic mechanical fasteners holding the at least two of the plurality of metallic components together, a transmission line, and a plurality of connectors arranged along the transmission line, wherein the plurality of connectors have similar PIM generation, wherein a spacing between the connectors along the transmission line being expressed by the formula: ((2n+F1)/4)×wavelength (where n is 0, 1, 2, 3, . . . ).

The metallic components may include couplers and the insulating material may be arranged between the couplers and the antenna. The couplers may be attached to the antenna with nonmetallic fasteners. The metallic components may include a bucket and the insulating material is an airspace between the bucket and the antenna. The bucket may be attached to the antenna with nonmetallic fasteners and wherein the bucket may have a length of one quarter (¼) of a wavelength in order to be bucket shorted. The metallic components may include a parasitic floating tilted dipole and the insulating material may include dielectric material arranged between the parasitic floating tilted dipole and the antenna. The parasitic floating tilted dipole may be attached to the antenna with nonmetallic fasteners. The metallic components may include a tubular conductor and a stub, and the insulating material may be arranged between the tubular conductor and the stub. The antenna may include a cover configured to cover an opening in the antenna, wherein the cover may be attached to the antenna with the non-metallic fasteners. The cover may be configured maintain an inert gas within the antenna.

There has thus been outlined, rather broadly, certain aspects of the invention in order that the detailed description thereof herein may be better understood, and in order that the present contribution to the art may be better appreciated. There are, of course, additional aspects of the invention that will be described below and which will form the subject matter of the claims appended hereto.

In this respect, before explaining at least one aspect of the invention in detail, it is to be understood that the invention is not limited in its application to the details of construction and to the arrangements of the components set forth in the following description or illustrated in the drawings. The invention is capable of aspects in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the invention. It is important, therefore, that the claims be regarded as including such equivalent constructions insofar as they do not depart from the spirit and scope of the invention.

### BRIEF DESCRIPTION OF THE DRAWINGS

FIG. 1A shows a portion of a transmission line with connectors constructed according to aspects of the disclosure.

FIG. 1B shows a portion of a transmission line with connectors constructed to achieve PIM reduction according to aspects of the disclosure.

FIG. 2 shows two couplers constructed according to aspects of the disclosure.

FIG. 3A shows perspective bottom view of a bucket shorted antenna constructed according to aspects of the disclosure.

FIG. 3B shows a top view of the bucket shorted antenna of FIG. 3B according to aspects of the disclosure.

FIG. 4 shows floating tilted dipoles constructed according to aspects of the disclosure.

FIG. 5 shows a waveguide diconical antenna constructed according to aspects of the disclosure.

FIG. 6 shows a pressurized slot cover constructed according to aspects of the disclosure.

FIG. 7 shows the theoretical basis for the generation of PIM frequencies.

FIG. 8 shows the results and frequencies in the transmission spectrum of PIM generation.

### DETAILED DESCRIPTION

The invention will now be described with reference to the drawing figures, in which like reference numerals refer to like parts throughout. Aspects of the invention advantageously reduce PIM in high-power applications.

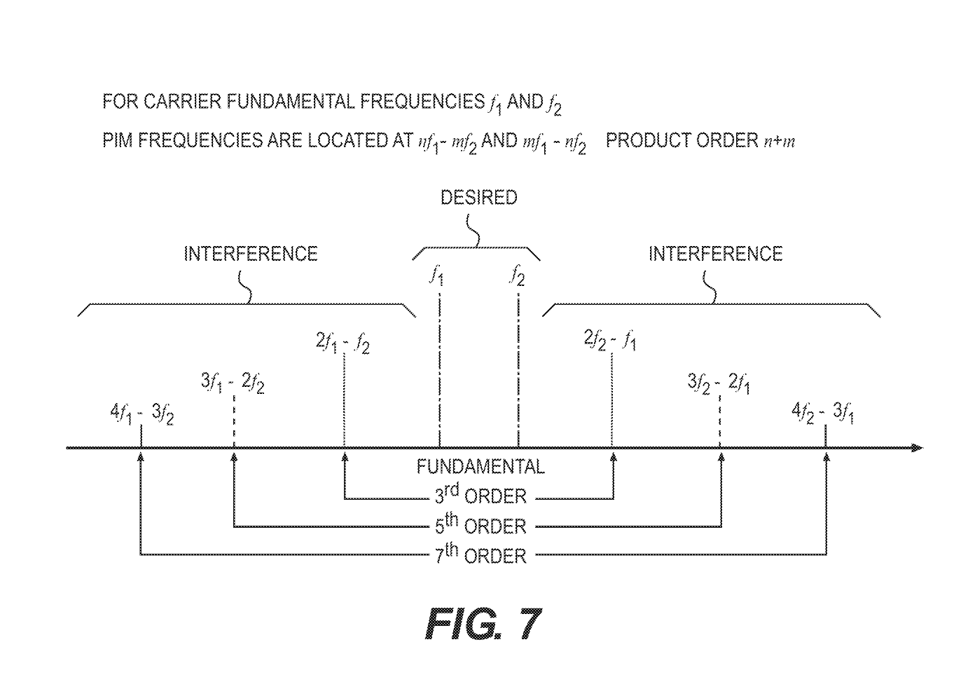

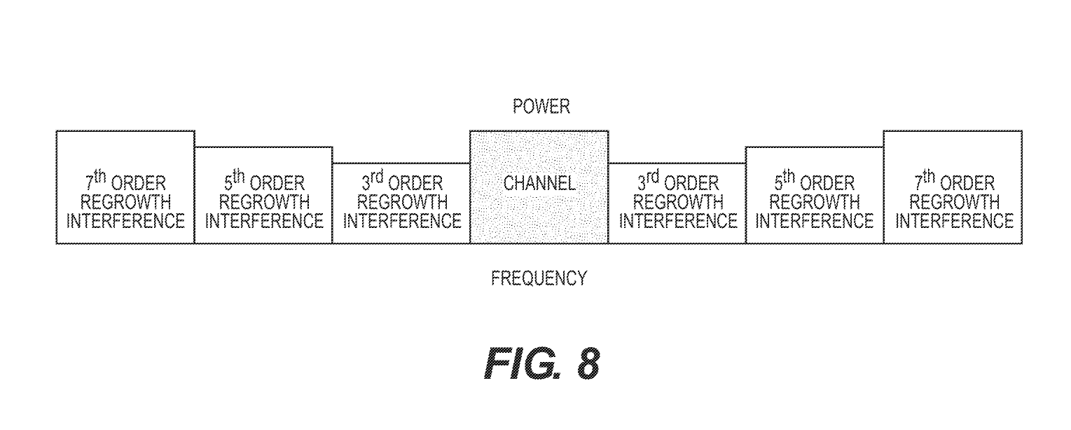

FIG. 7 shows the theoretical basis for the generation of PIM frequencies; and FIG. 8 (Not drawn to scale), shows the results and frequencies in the transmission spectrum of PIM generation. In particular, FIG. 7 shows the interference generated by the fundamental carrier frequencies f1 and f2. In this regard, f1 and f2 may generate nth order interference as shown in FIG. 7. FIG. 8 shows the theoretical power associated with a third order regrowth, a fifth order regrowth, and seventh order regrowth of interference from PIM generation. The issues related to PIM generation may become even more problematic with the changes in broadcast spectrum that are being reallocated by the Federal Communications Commission. Accordingly, the new spectrum reallocation will place a number of wireless frequencies very close to broadcast frequencies. This increases the need to control PIM generation in the broadcast frequencies.

PIM generation may take place in a RF system, a transmission line, an antenna feed network, and/or an antenna. The invention focuses on reducing PIM level in the transmission line, the antenna feed network, and/or the antenna structure. However, the concepts described herein may be utilized and applied in other locations as well.

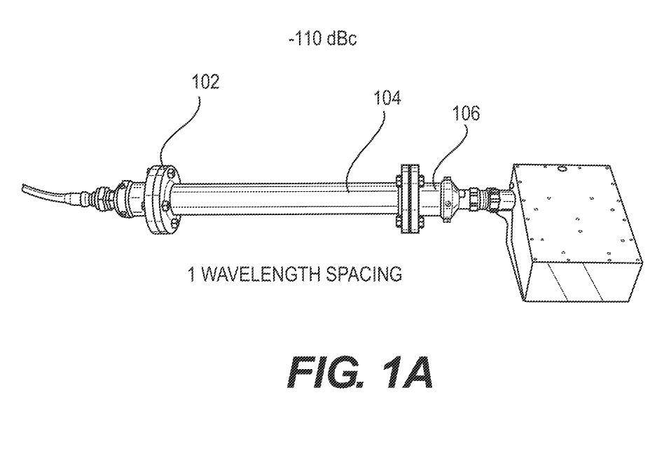

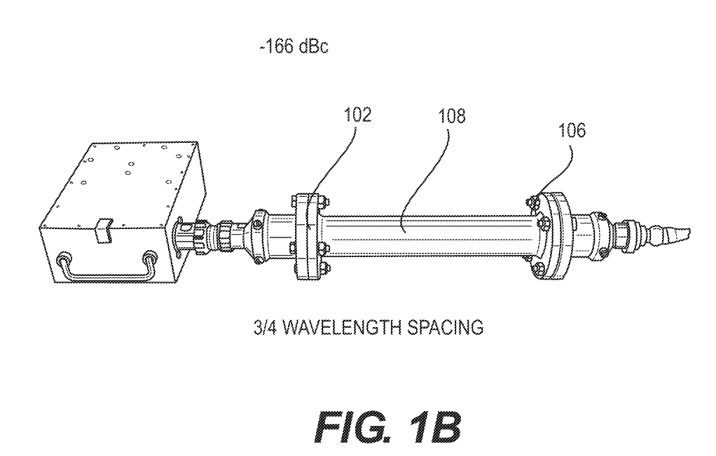

FIG. 1A shows a portion of a transmission line with connectors constructed according to aspects of the disclosure. More specifically, FIG. 1A shows a portion of a transmission line 104 with connectors 102, 106 in a test environment. In particular, according to the invention high power flexible feed lines should be of a single length for a tower run in order to reduce PIM generation. However, in practice it is often not possible to have a single length of feed line for a tower run and the feed line may require one or more connectors. This is especially the case with high-power broadcast transmission lines due to the increased size of the transmission lines associated with the increased power. For example, power transmission that exceeds 5 kW. This is due in part because the high-power transmission lines are much larger and not flexible. Accordingly, the use of connectors may not be avoided and the connectors in some instances can generate PIM. In one experiment when testing with 2×20 W tones, by the inventor, the connectors were found to have an undesirable PIM generation of −116 dBc to −119 dBc. When these connectors were arranged at one wavelength spacing as shown in FIG. 1A, the resultant PIM generation was found to be an undesirable −110 dBc.

In accordance with the invention, the PIM generation of connectors may be reduced or substantially eliminated by constructing an arrangement as shown in FIG. 1B. In particular, the same connectors were arranged with a transmission line 108 having a ¾ wavelength spacing. At this spacing, the PIM generated by the connectors was substantially reduced to a more acceptable to −166 dBc. In this regard, the connectors need to have a similar amount of PIM generation. The similar PIM generation is required in order for the subsequent spacing to cancel the associated PIM. It was furthermore found that the spacing may be at odd fourths of the wavelength (¼, ¾, 5/4, and the like). Accordingly, the wavelength spacing could be expressed by the formula: ((2n+1)/4)×wavelength (where n is 0, 1, 2, 3, . . . ). Additionally, lower values of n provide greater PIM generation cancellation.

The associated process with this arrangement may include determining the PIM generation for a particular connector. If the connector does not generate PIM exceeding a first threshold (higher than −150 dBc for example), take no action. On the other hand, if the connector generates PIM exceeding the first threshold, obtain a connector having similar PIM generation and arrange that second connector along the transmission line consistent with the spacing noted above.

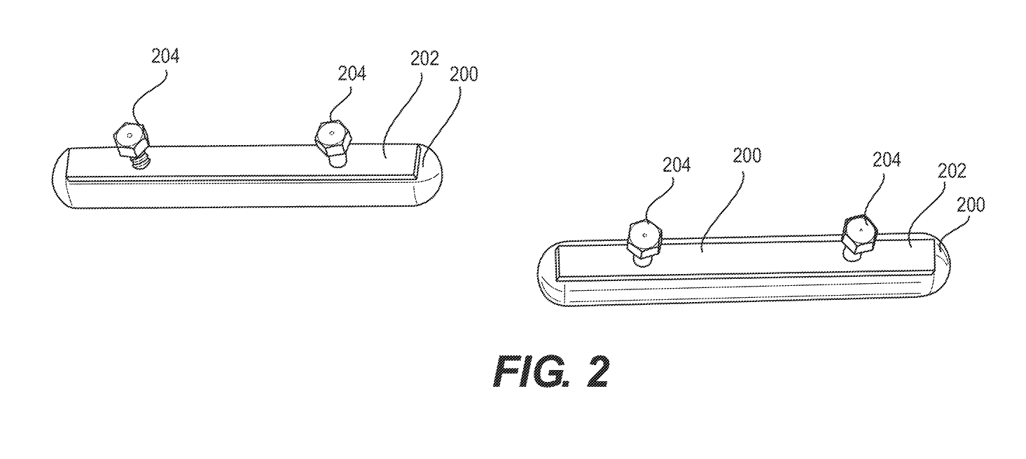

FIG. 2 shows two couplers constructed according to aspects of the disclosure. Components of the antenna can also generate PIM in a number of different situations. For example, the antenna may use a number of structures, such as metallic structures that include connecting (or contacting) surfaces and mechanical fasteners. According to the invention, at least some of these metallic structures should be insulated from one another. Moreover, the mechanical fasteners attaching the metallic structures to one another should be nonmetallic. For example, an antenna may include couplers 200 as shown in FIG. 2. Typically the couplers 200 may be attached to the antenna with a direct metal to metal connection together with metallic mechanical fasteners. According to the invention, at least some of the components of the antenna should be joined together with insulating or dielectric material therebetween. Other methods of insulating components are contemplated as well. Additionally, the mechanical fasteners utilized to attach the components to the antenna should also be nonmetallic. As shown in FIG. 2, the couplers 200 may include a strip of insulating material 202. The strip of insulating material 202 may be arranged between the coupler 200 and other portions of the antenna structure. Additionally, as shown in FIG. 2, the couplers 200 may include nonmetallic mechanical fasteners 204. The nonmetallic mechanical fasteners 204 in this case are fiberglass bolts. Other types of nonmetallic mechanical fasteners are contemplated as well. Accordingly, the arrangement of the various antenna structures with insulating material arranged therebetween and nonmetallic mechanical fasteners reduces PIM generation in the antenna. Although FIG. 2 shows couplers having the insulating material and nonmetallic mechanical fasteners, other antenna components may utilize the same approach to reducing PIM generation.

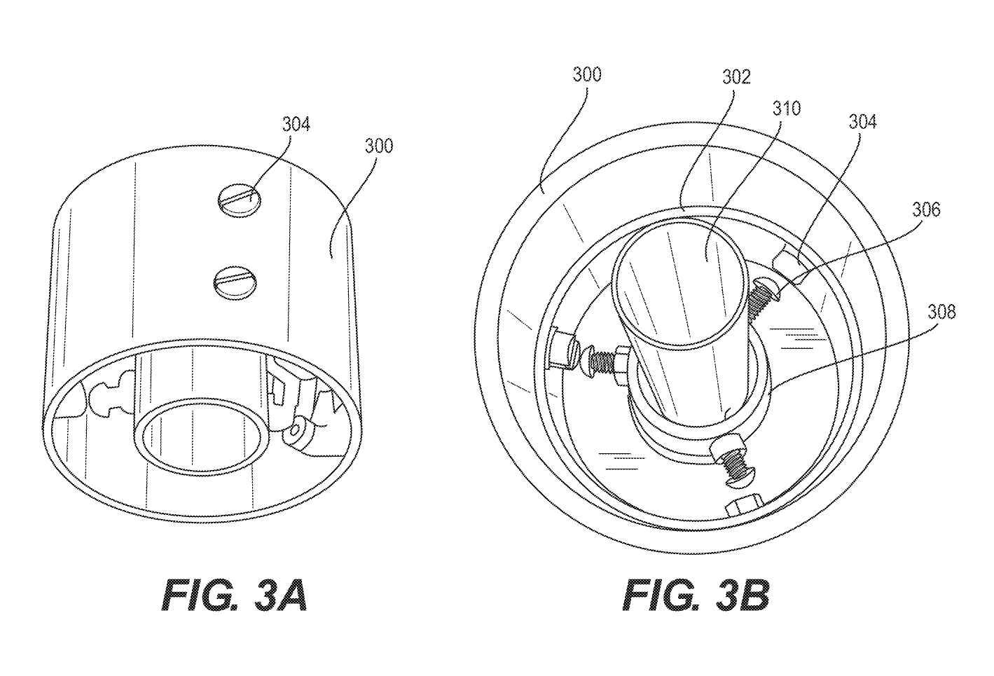

FIGS. 3A and 3B show a bucket shorted antenna constructed according to aspects of the disclosure. In particular, FIG. 3A includes a perspective bottom view and FIG. 3B a top view. Further, FIG. 3A and 3B both show an antenna structure 300 utilizing a similar approach as above. In particular, the antenna 300 includes a bucket 302. In this case, the bucket 302 may have a length of one quarter (¼) of a wavelength in order to be bucket shorted instead of directly shorted to the antenna. The bucket 302 may have a flat closed-end and an open end. The closed end of the bucket 302 producing a RF short at the face of the bucket. The bucket 302 is shown in the left image as including a plurality of nonmetallic mechanical fasteners 304. When the bucket 302 is arranged in the antenna 300 as shown in the right image, the mechanical fasteners 304 extend out to the internal diameter of the antenna 300 to provide a mechanical connection thereto. Additionally, the bucket 302 may include additional mechanical fasteners 306 arranged on an internal cylindrical section 308. This internal cylindrical section 308 may be arranged around a pipe portion 310. The nonmetallic mechanical fasteners 306 may extend from the internal cylindrical section 308 to contact the pipe 310 and provide additional mechanical fastening of the bucket 302 to the antenna 300. Again the arrangement shown in FIGS. 3A and 3B avoids metal to metal contact between various antenna components and the avoidance of nonmetallic mechanical fasteners and accordingly the PIM generation is reduced.

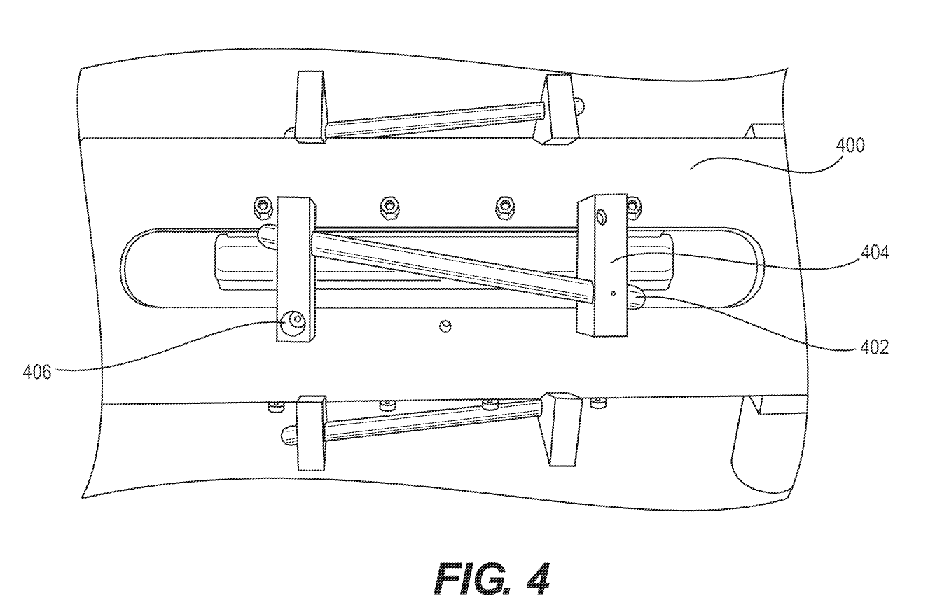

FIG. 4 shows floating tilted dipoles constructed according to aspects of the disclosure. In particular, FIG. 4 shows an antenna 400 having dipoles 402. The dipoles 402 may be insulated with a dielectric material 404 in their attachment to the antenna 400. Additionally, the dipoles 402 and dielectric material 404 may connect to the antenna 400 with nonmetallic mechanical fasters 406. The use of the insulating structure between the metallic components and the nonmetallic fasteners reducing PIM generation. Further details on the floating tilted dipoles are set forth in U.S. Pat. No. 4,899,165, filed Oct. 20, 1988, issued Feb. 6, 1990, entitled Variable circular polarization antenna having parasitic floating tilted dipole, and U.S. Pat. No. 4,583,098 filed Aug. 31, 1984, issued Apr. 15, 1986, entitled Circularly polarized antenna using axial slot and slanted parasitic radiator, both incorporated by reference herein in their entirety.

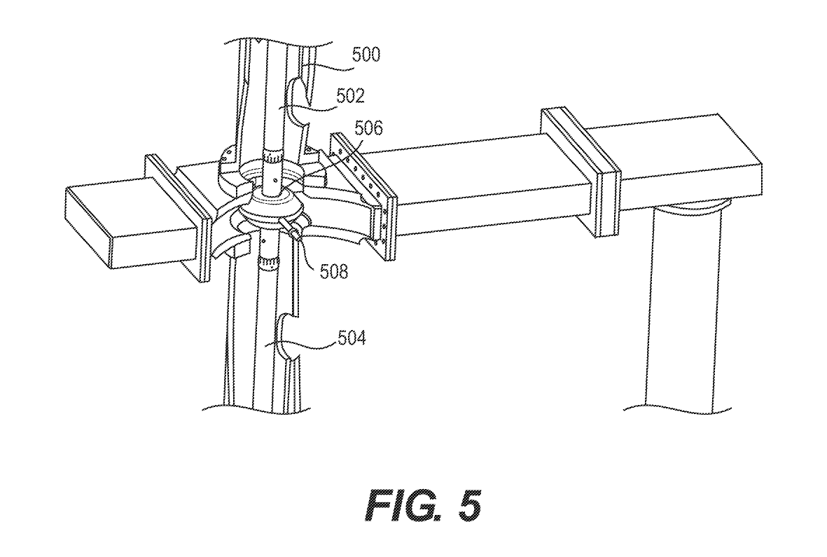

FIG. 5 shows a waveguide diconical antenna constructed according to aspects of the disclosure. In particular, the antenna 500 includes an inner tubular conductor having an upper half 502 and a lower half 504. The upper half 502 and the lower half 504 may be connected by a stub 506. Similar to the above, the antenna 500 may include insulating structure between each of the metallic components and nonmetallic fasteners such as fastener 508. The use of the insulating structure between the metallic components and the nonmetallic fasteners reducing PIM generation. Further details regarding the waveguide diconical antenna structure are set forth in U.S. Pat. No. 4,988,961, filed Aug. 10, 1989, issued Jan. 29, 1991, entitled Device for achieving minimal reflections in antenna coupling, incorporated by reference herein in its entirety.

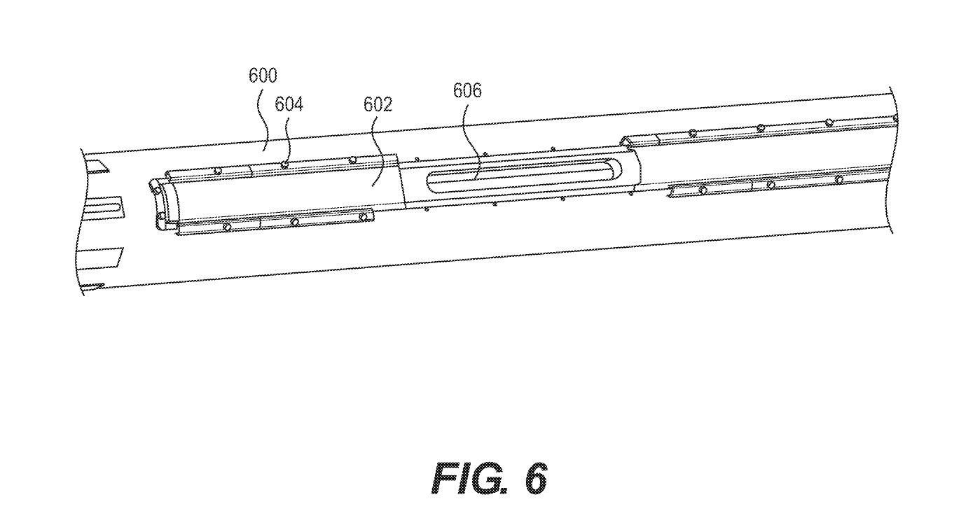

FIG. 6 shows a pressurized slot cover constructed according to aspects of the disclosure. Additionally, it has been determined that corrosion may also increase the generation of PIM in various antenna components. To reduce corrosion, a number of different approaches may be taken with respect to the antenna including encasing, coating, covering, and the like in order to limit or prevent corrosion in antenna structure and accordingly minimize PIM generation. In this regard, one approach is shown in antenna 600 shown in FIG. 6. In this regard antenna 600 may include a slot 606. This slot 606 may be exposed to the environment and may allow for some level of corrosion with respect to the internal structure of the antenna 600. In this regard, a cover 602 may be arranged over the slot 606 of the antenna 600. The cover 602 may be attached to the antenna 600 with various mechanical fasteners 604 which may be nonmetallic. Accordingly, any form of corrosion resistance may reduce PIM generation by various antenna components. Moreover, the antenna 600 with the cover 602 may be pressurized with an inert gas such as nitrogen. This further reduces the corrosion process.

Additionally, a number of further processes may be applied to the power line and antenna structure to reduce PIM generation. These processes may include one or more of the following basic design and workmanship concepts, environmental concepts, and the construction concepts. Regarding basic design and workmanship concepts, the transmission lines and antenna should avoid using Ferromagnetic materials, such as Steel and Nickel. Moreover, the transmission lines and antenna should avoid having any burrs or metal flakes in the construction thereof. Regarding environmental concepts, the transmission lines and antenna should be constructed being mindful of the tower itself, nearby fences, nearby barn roofs, rusty bolts, guy wires, and the like. Finally, the transmission lines and antenna should be constructed minimizing “Spotty” Micro-contacts, voids, loose or poorly torqued connections or bolts, fatigue breaks/cracks, intermittent contacts, cold solder joints, junction contaminants, scratches on mating surfaces, misaligned parts, and the like.

Accordingly, an aluminum slotted antenna as described above having limited metal to metal contacts with various components and limited mechanical fasteners will generate less PIM. Of course, other antenna types are contemplated as well. Moreover, the transmission line feed to any transmission system having connectors as described herein will also generate less PIM.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

1. An antenna comprising:
a plurality of metallic components;
the plurality of metallic components arranged to provide transmission of a high-power broadcast signal;
at least two of the plurality of metallic components being configured to be connected to one another;
an insulating material arranged between the at least two of the plurality of metallic components; and
nonmetallic mechanical fasteners holding the at least two of the plurality of metallic components together.

2. The antenna according to claim 1 wherein the metallic components comprise couplers and the insulating material is arranged between the couplers and the antenna.

3. The antenna according to claim 2 wherein the couplers are attached to the antenna with nonmetallic fasteners.

4. The antenna according to claim 1 wherein the metallic components comprise a bucket and the insulating material is an airspace between the bucket and the antenna.

5. The antenna according to claim 4 wherein the bucket is attached to the antenna with nonmetallic fasteners and wherein the bucket has a length of one quarter (¼) of a wavelength in order to be bucket shorted.

6. The antenna according to claim 1 wherein the metallic components comprise a parasitic floating tilted dipole and the insulating material is dielectric material arranged between the parasitic floating tilted dipole and the antenna.

7. The antenna according to claim 6 wherein the parasitic floating tilted dipole is attached to the antenna with nonmetallic fasteners.

8. The antenna according to claim 1 wherein the metallic components comprise a tubular conductor and a stub; and wherein the insulating material is arranged between the tubular conductor and the stub.

9. The antenna according to claim 1 further comprising a cover configured to cover an opening in the antenna, wherein the cover is attached to the antenna with the non-metallic fasteners.

10. The antenna according to claim 9 wherein the cover is configured to maintain an inert gas within the antenna.

11. The antenna according to claim 1 further comprising:
a transmission line; and
a plurality of connectors arranged along the transmission line, wherein the plurality of connectors have similar PIM generation;
wherein a spacing between the connectors along the transmission line being expressed by the formula: ((2n+1)/4)×wavelength (where n is 0, 1, 2, 3, . . . ).

12. An antenna comprising:
a plurality of metallic components;
the plurality of metallic components arranged to provide transmission of a high-power broadcast signal;
at least two of the plurality of metallic components being configured to be connected to one another;
an insulating material arranged between the at least two of the plurality of metallic components;
nonmetallic mechanical fasteners holding the at least two of the plurality of metallic components together;
a transmission line; and
a plurality of connectors arranged along the transmission line, wherein the plurality of connectors have similar PIM generation,
wherein a spacing between the connectors along the transmission line being expressed by the formula: ((2n+1)/4)×wavelength (where n is 0, 1, 2, 3, . . . ).

13. The antenna according to claim 12 wherein the metallic components comprise couplers and the insulating material is arranged between the couplers and the antenna.

14. The antenna according to claim 13 wherein the couplers are attached to the antenna with nonmetallic fasteners.

15. The antenna according to claim 12 wherein the metallic components comprise a bucket and the insulating material is an airspace between the bucket and the antenna.

16. The antenna according to claim 15 wherein the bucket is attached to the antenna with nonmetallic fasteners and wherein the bucket has a length of one quarter (¼) of a wavelength in order to be bucket shorted.

17. The antenna according to claim 12 wherein the metallic components comprise a parasitic floating tilted dipole and the insulating material is dielectric material arranged between the parasitic floating tilted dipole and the antenna.

18. The antenna according to claim 17 wherein the parasitic floating tilted dipole is attached to the antenna with nonmetallic fasteners.

19. The antenna according to claim 12 wherein the metallic components comprise a tubular conductor and a stub; and wherein the insulating material is arranged between the tubular conductor and the stub.

20. The antenna according to claim 12 further comprising a cover configured to cover an opening in the antenna, wherein the cover is attached to the antenna with the non-metallic fasteners, wherein the cover is configured maintain an inert gas within the antenna.
